(19) United States
(12) Patent Application Publication
(10) Pub. No.: US 2026/0023278 A1
(43) Pub. Date: Jan. 22, 2026

(54) TRIM ELEMENT

(71) Applicant: Faurecia Clarion Electronics Europe, Paris (FR)

(72) Inventors: Edouard DA SILVA, PONTOISE (FR); Tara AKHAVAN, PARIS (FR)

(21) Appl. No.: 19/271,457

(22) Filed: Jul. 16, 2025

(30) Foreign Application Priority Data
Jul. 16, 2024 (FR) FR 24 07769

(51) Int. Cl. G02F 1/1333; G02F 1/13357

(52) U.S. Cl. CPC G02F 1/13332; G02F 1/133603

(57) ABSTRACT

A trim element that includes: a cover lens at least partially transparent and having a zone defining a front-end display surface, at least one display layer extending in parallel to the cover lens, opposite to the front-end display surface, and a backlighting device having at least one backlighting unit for backlighting said display layer, the backlighting unit(s) being controlled by a control unit implemented on a printed circuit board. The trim element further includes a thin front light film, extending between the cover lens and the display layer, the backlighting device having at least one infrared light emitting unit emitting infrared light through the thin front light film and towards the front-end display surface.

### CROSS-REFERENCE TO RELATED APPLICATIONS

This application claims priority to French Patent Application No. 2407769 filed Jul. 16, 2024, the entire disclosure of which is incorporated by reference herein.

### TECHNICAL FIELD

The present invention relates to a trim element.

The invention is in the field of vehicle interior lighting units, for example backlighting units to enable various vehicle displays.

### BACKGROUND

It is known to integrate a display device into a trim element, such as a dashboard, a center console, a seat, a door panel or the like, so as to display information and/or audiovisual content for vehicle passengers.

Several solutions have been proposed for trim elements comprising an integrated display device, the display device being lit by one or several backlighting units, for example forming a luminous sheet of light-emitting diodes (LEDs) as described in patent application FR3122616.

Also, it is known to provide other functionalities for vehicle drivers and occupants, in particular monitoring systems of vehicle driver and occupants, also referred to as cabin monitoring systems. In particular, driver monitoring systems are used to analyze the driver awareness or drowsiness, so as to provide warnings if driver drowsiness is detected, in order to improve safety and prevent accidents. In some more advanced applications, the driver monitoring systems may further trigger applying brakes or autonomous vehicle steering.

Generally, the driver or occupant monitoring systems comprise a processing subsystem, a camera or sensor and a light source, in order to illuminate the cabin of the vehicle for sensing an image of the driver or occupant of the vehicle. A solution that may be envisaged is to use LED spots to light the cabin, but this solution is not satisfying because the spots create a gradient of brightness in the sensed images, and therefore the sensed images may be saturated, and the monitoring is less efficient. Another existing solution is to use infrared LED spots to light the cabin, however, the infrared LED spots could stay as red points and disturb the driver since it gives an impression to the driver as being monitored. It is desirable to use light sources emitting light outside the visible light wavelengths and that the emitted light does not disturb the driver.

An object of the invention is to alleviate the drawbacks of the known solutions, while reducing the bulkiness of equipment for vehicle cabins.

### SUMMARY

To this end, the invention proposes a trim element comprising a cover lens at least partially transparent, comprising a zone defining a front-end display surface, at least one display layer extending in parallel to the cover lens, opposite to the front-end display surface, a backlighting device comprising at least one backlighting unit for backlighting said display layer, the backlighting unit(s) being controlled by a control unit implemented on a printed circuit board. The trim element further comprises a thin front light film, extending between the cover lens and the display layer, the backlighting device comprising at least one infrared light emitting unit emitting infrared light through the thin front light film and towards the front-end display surface.

Advantageously, the trim element proposed enables both functionalities of informative or decorative display on the one hand, and cabin infrared illumination for sensing purposes on the other hand, the overall bulkiness being reduced as compared to using two separate devices, one for informative or decorative display and another one for cabin infrared illumination for sensing purposes.

In embodiments of the invention, the trim element comprises one or more of the following features, considered alone or according to all technically possible combinations:
the at least one infrared light emitting unit is controlled by said control unit;
said backlighting device is composed of a matrix of light-emitting didoes, comprising a plurality of sub-matrices of light-emitting diodes, at least one sub-matrix being a backlighting unit adapted to emit visible light, and at least one other sub-matrix being an infrared light emitting unit, said sub-matrices of light-emitting diodes being controlled independently from each other;
said at least one infrared light emitting unit is configured to emit infrared light in the domain of near infrared, of a wavelength comprised between 0.78 μm and 3 μm;
the at least one display layer comprises a liquid crystal panel;
the at least one display layer comprises a decorative layer;
the at least one display layer comprises a liquid crystal panel and a decorative layer;
the thin front light film is connected to the at least one infrared light emitting unit via a coupling element forming an infrared light guide;
the coupling element is a portion of the thin front light film, extending from a border of said thin front light film, and folded towards said printed circuit board;
the thin front light film is flexible and has a thickness smaller than or equal to 0.5 millimeters, preferably a thickness between 0.03 mm and 0.2 mm.

### BRIEF DESCRIPTION OF THE DRAWINGS

Further characteristics and advantages of the present invention will become apparent from the following description, provided merely by way of non-limiting example, with reference to the enclosed drawings, in which:

FIG. 1 represents schematically a trim element according to an embodiment;

FIG. 2 is an exploded cross sectional representation of layers the trim element of FIG. 1, according to an embodiment; and

FIG. 3 is a functional representation of lighting units according to an embodiment.

### DETAILED DESCRIPTION

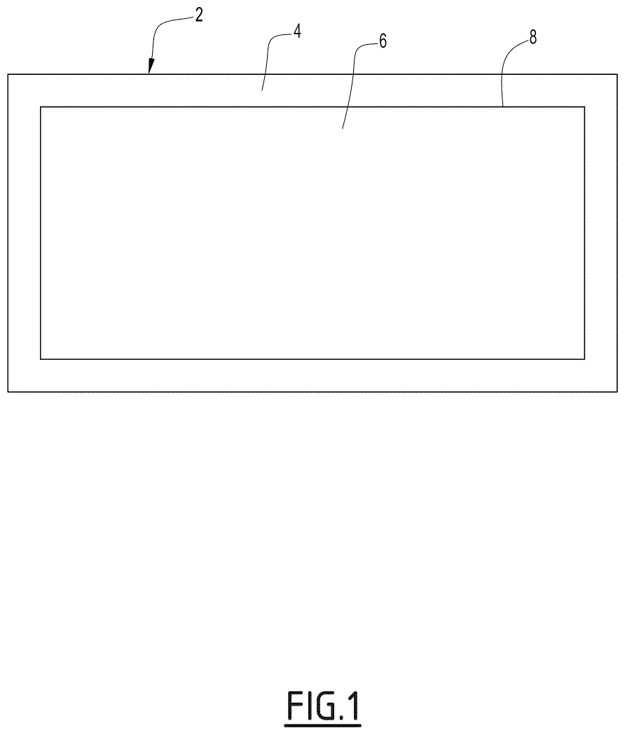

With reference to FIGS. 1 to 3, a vehicle trim element 2 is described, which may be advantageously inserted in the cabin of a vehicle.

Such a trim element 2 forms an instrument panel, a center console, a seat, a door panel or the like, installed in the vehicle interior, for example.

In a variant, the trim element 2 is a display module that can be integrated into another trim element such as a dashboard, etc. Such a display module forms a finished product, for example, which can be used as a stand-alone unit, for example, to be arranged in a vehicle or the room of a building or used nomadically. Thus, the trim element 2 of FIG. 1 can be installed on a dashboard of a vehicle.

The trim element 2 comprises an edge part 4 and a display surface 6, the display surface 6 being a zone of a cover lens 8. The edge part 4 defines the appearance of at least a part of the trim element 2, and the edge part 4 may be made of any material suitable to provide a satisfactory appearance to the trim element 2.

The display surface 6 is also called a front-end display surface since it faces a viewer.

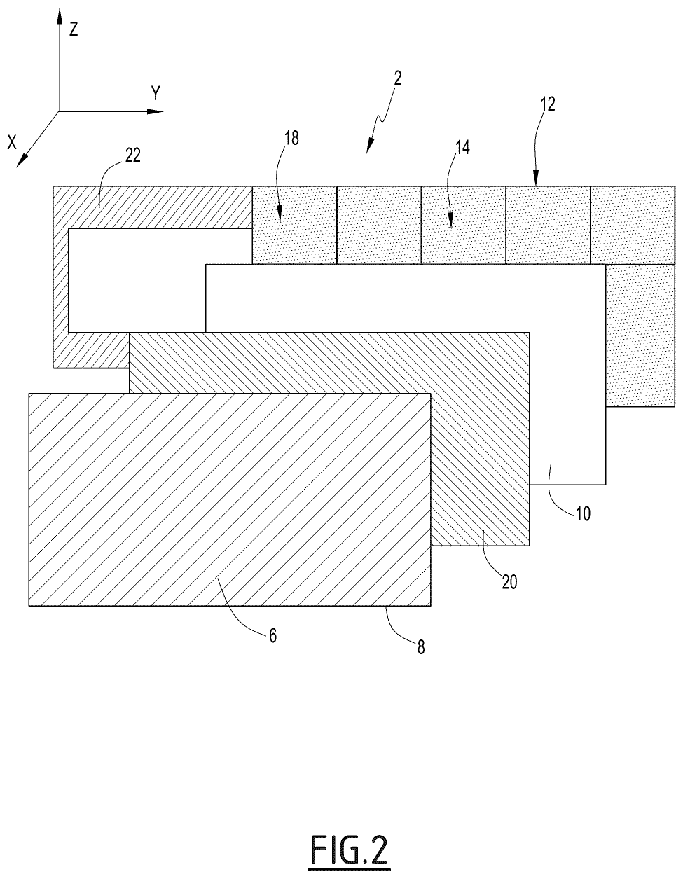

For example, when the trim element 2 is installed in the interior of a vehicle (e.g. in the vehicle's cabin), the display surface 6 faces the interior of the vehicle. The front-end direction, e.g. towards the interior of the vehicle, is indicated by the arrow of axis X of the spatial reference frame (X, Y, Z) of FIG. 2.

The cover lens 8 is translucent, and is at least partially transparent.

Translucent means a light transmission rate substantially between 5% and 85%, with a light transmission rate of less than 5% corresponding to an opaque part not letting light to pass through.

Transparent means a light transmission rate above 85%.

In some embodiments, the cover lens 8 is entirely transparent and is made for example of plastic material, glass or the like.

As shown in the exploded view of FIG. 2, according to an embodiment, the trim element 2 also comprises a display layer 10, extending in parallel to the cover lens 8, opposite to the front-end display surface 6. In other words, the display layer 10 is placed behind the cover lens 8, taking into consideration the direction indicated by the arrow of axis X.

The trim element 2 further comprises a backlighting device 12, positioned behind the display layer 10 and comprising one or several backlighting units 14 adapted to illuminate the display layer 10 by emitting visible light. The backlighting device 12 is controlled by a control unit 32, implemented on a printed circuit board.

According to an embodiment, the display layer 10 is a liquid crystal panel, for example a Thin Film Transistor (TFT) display.

According to a different embodiment, the display layer 10 may be a decorative layer comprising at least one transparent zone and at least one opaque zone, or a plurality of transparent and opaque zones forming a pattern. For example, the decorative layer is made of a thin film, and comprises perforations which create a visible pattern when backlit by the backlighting device 12.

According to yet another embodiment, not represented, the trim element comprises two display layers, such as a liquid crystal panel and a decorative layer, the decorative layer being in front of the liquid crystal panel.

According to an embodiment, the backlighting device 12 is formed by a sheet of light-emitting diodes (LEDs), each LED being adapted to emit a light signal, of chosen or controllable wavelength. Preferably, the sheet of LEDs is flexible and deformable, for example, so that its shape can be adapted to its environment in the trim element, the LEDs being particularly thin, of thickness substantially in the range of 1 mm to 5 mm, for example, preferably in the range of 2 mm to 3 mm. Advantageously, such a thin, flexible sheet of LEDs saves space and can be arranged to adopt a desired shape.

The backlighting device 12 comprises at least one, and preferably several, backlighting units 14, configured to emit light signals in the visible light spectrum, such as white light or coloured light, for example Red, Green, Blue lights, suitable for backlighting the display layer 10.

Advantageously, the trim element 2 further comprises a thin front light film 20, extending in parallel to the cover lens 8, opposite to the display surface 6. The thin front light film 20 is adapted to guide a light entering in it and to diffuse the light homogeneously along a pre-defined zone of the thin front light film.

According to an embodiment, the thin front light film 20 extends between the cover lens and the display layer 10.

According to an embodiment, when the trim element comprises a decorative layer, the thin front light film 20 extends behind the decorative layer.

Advantageously, the thin front light film 20 is particularly thin, its thickness being typically less than or equal to 0.5 mm, for example, preferably in the range between 0.03 mm and 0.2 mm The thin front light film 20 is also flexible, and is for example made of optical grade Polycarbonate (PC) or Polymethyl methacrylate (PMMA).

Advantageously, the thin front light film 20 is connected to at least one infrared light emitting unit 18 via a coupling element 22, so as to form an infrared light guide, emitting infrared light towards the front-end display surface 6.

In the example of FIG. 2, the infrared light emitting unit 18 is composed of a plurality of LEDs of the backlighting unit 12, which are adapted to emit a light signal in the infrared spectrum, and more preferably in the near infrared spectrum, i.e. having a wavelength comprised between 0.78 μm and 3 μm.

For example, the backlighting device 12 comprises a plurality of LEDs forming a matrix of LEDs, and comprising several sub-matrices 14, 18 of LEDs, each sub-matrix being controllable independently from the other sub-matrices. Therefore, the sub-matrices may emit the same or different light signals, of different wavelengths and/or intensities.

The coupling element 22 is for example of the same material as the thin front light film 20, preferably extends from a border of the thin front light film 20 towards the infrared light emitting unit 18.

In another embodiment not presented in the Figures, the coupling element is an elongated lightguide with two opposite terminal ends, one terminal end connecting to the front light film 20 and with another terminal end connecting to the at least one infrared light emitting unit 18, so that the elongated lightguide diffuses the infrared light along a border of the thin front light film 20.

Any other embodiments for coupling the infrared light emitting unit 18 to the thin light film 20 known by a skilled person are applicable.

Advantageously, the infrared light is guided to the front-end, and is emitted towards the front-end direction, through the transparent areas of the cover lens, so as to illuminate the cabin of the vehicle with infrared light.

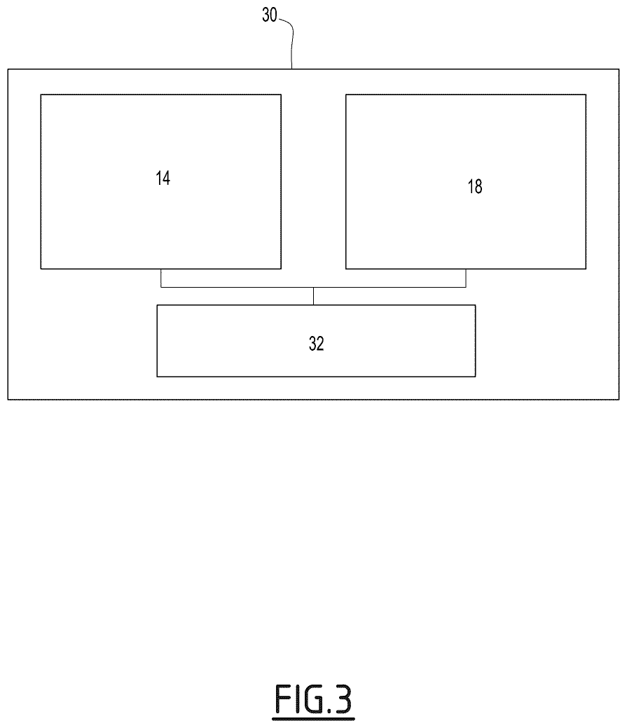

According to a preferred embodiment, as shown in FIG. 3, the infrared light emitting unit(s) 18 are integrated with the backlighting unit(s) 14, on a same printed board circuit 30, and controlled by a same control unit 32. In this embodiment, the coupling element 22 extends from a border of the thin front light film 20, folded towards the printed circuit board 30. This embodiment is advantageous because the backlighting units 14 for backlighting the display layer 10 and the infrared light emitting units 18 are packaged together, so the overall space taken by the lighting units is minimized.

Furthermore, advantageously, all the infrared light emitting units emit through the whole of the display surface, which provides a larger infrared lighting surface, and therefore improves the driver and occupant monitoring systems precision.

According to variants, the cover lens may define a display surface extending beyond the surface of the display layer, which forms a main display surface, the display surface further comprising one or several peripheral surfaces, as described in patent application FR3122616. In such an embodiment, the thin front light film 20 may extend on the whole display surface, including the main display surface and the peripheral display surfaces. Advantageously, the infrared light emitting surface is even further extended.

1. A trim element comprising:
a cover lens at least partially transparent, comprising a zone defining a front-end display surface,
at least one display layer extending in parallel to the cover lens, opposite to the front-end display surface, and
a backlighting device comprising at least one backlighting unit for backlighting said display layer, the backlighting unit(s) being controlled by a control unit implemented on a printed circuit board,
the trim element further comprising a thin front light film, extending between the cover lens and the display layer,
the backlighting device comprising at least one infrared light emitting unit emitting infrared light through the thin front light film and towards the front-end display surface.

2. The trim element according to claim 1, wherein said at least one infrared light emitting unit is controlled by said control unit.

3. The trim element according to claim 1, wherein said backlighting device comprises a matrix of light-emitting didoes, comprising a plurality of sub-matrices of light-emitting diodes, at least one sub-matrix being a backlighting unit adapted to emit visible light, and at least one other sub-matrix being an infrared light emitting unit, said sub-matrices of light-emitting diodes being controlled independently from each other.

4. The trim element according to claim 1, wherein said at least one infrared light emitting unit is configured to emit infrared light in the domain of near infrared, of a wavelength between 0.78 μm and 3 μm.

5. The trim element according to claim 1, wherein the at least one display layer comprises a liquid crystal panel.

6. The trim element according to claim 1, wherein the at least one display layer comprises a decorative layer.

7. The trim element according to claim 1, wherein the at least one display layer comprises a liquid crystal panel and a decorative layer.

8. The trim element according to claim 1, wherein said thin front light film is connected to the at least one infrared light emitting unit via a coupling element forming an infrared light guide.

9. The trim element according to claim 8, wherein said coupling element is a portion of the thin front light film, extending from a border of said thin front light film, and folded towards said printed circuit board.

10. The trim element according to claim 1, wherein the thin front light film is flexible and has a thickness smaller than or equal to 0.5 millimeters.

11. The trim element according to claim 10, wherein the thin front light film has a thickness between 0.03 mm and 0.2 mm.
